(19) United States
(12) Patent Application Publication
(10) Pub. No.: US 2026/0316319 A1
(43) Pub. Date: Oct. 15, 2026

(54) Chainsaw Power Tool And Tensioning Assembly

(71) Applicant: Techtronic Cordless GP, Anderson, SC (US)

(72) Inventor: Christopher Alan Holman, Clemson, SC (US)

(21) Appl. No.: 19/465,836

(22) Filed: Jan. 30, 2026

Related U.S. Application Data
(60) Provisional application No. 63/752,325, filed on Jan. 31, 2025.

(51) Int. Cl. B27B 17/14; B27B 17/00; B27B 17/02; B27B 17/08

(52) U.S. Cl. CPC B27B 17/14; B27B 17/0008; B27B 17/02; B27B 17/08

(57) ABSTRACT

The chainsaw includes a guide bar, a chain, a housing, a sprocket, and a reset lever. The guide bar may include an outer track. The chain may be movably coupled to the outer track. The housing may define an interior. The drive sprocket may be mounted on the housing in mechanical communication with the chain to motivate movement thereof. The reset lever may be attached to the drive sprocket. The reset lever may be longitudinally movable with the sprocket relative to the housing to vary tension at the chain.

### CROSS-REFERENCE TO RELATED APPLICATIONS

The present application claims priority to U.S. Provisional Application Serial No. 63/752325 filed on Jan. 31, 2025, the disclosure of which is incorporated by reference herein in its entirety.

### FIELD

The present disclosure relates generally to outdoor power tools, such as chainsaws.

### BACKGROUND

Outdoor power tools such as chainsaws utilize a moving chain with teeth to cut into material, such as wood. The teeth are driven along an outer path of a guide bar in a continuous manner by a driving element. The driving element is controlled by a trigger located on a handle of the chainsaw. As the operator engages the trigger, the speed of the driving element changes, resulting in operation of the chainsaw.

Traditional chainsaws lack suitable tensioning systems for adjusting tension in the chain. As a result, chains are typically left in their tensioned states for prolonged periods of time, resulting in quicker fatigue and wear.

Accordingly, improved chainsaws and chainsaw tensioning systems are desired in the art. In particular, chainsaw tensioning systems which provide easier tensioning operation would be advantageous.

### BRIEF DESCRIPTION

Aspects and advantages of the present disclosure will be set forth in part in the following description, or may be obvious from the description, or may be learned through practice of the technology.

In accordance with one embodiment, a chainsaw is provided. The chainsaw may include a guide bar, a chain, a housing, a sprocket, and a reset lever. The guide bar may include an outer track. The chain may be movably coupled to the outer track. The housing may define an interior. The drive sprocket may be mounted on the housing in mechanical communication with the chain to motivate movement thereof. The reset lever may be attached to the drive sprocket. The reset lever may be longitudinally movable with the sprocket relative to the housing to vary tension at the chain.

In accordance with another embodiment, a chainsaw is provided. The chainsaw may include a housing, a guide bar, a chain, a drive sprocket, a reset lever, and a tensioning spring. The housing may define an interior. The guide bar may be fixed relative to the housing and include an outer track. The chain may be movably coupled to the outer track. The drive sprocket may be mounted on the housing in mechanical communication with the chain to motivate movement thereof. The reset lever may be attached to the drive sprocket. The reset lever may be movable with the drive sprocket relative to the housing to vary tension at the chain. The tensioning spring may be attached to the drive sprocket and the reset lever in rearward biased engagement.

In accordance with yet another embodiment, a chainsaw is provided. The chainsaw may include a housing, a guide bar, a chain, a drive sprocket, a reset lever, a gear plate, a system motor, a toothed rack, and a pawl. The housing may define an interior. The guide bar may be fixed relative to the housing and include an outer track. The chain may be movably coupled to the outer track. The drive sprocket may be mounted on the housing in mechanical communication with the chain to motivate movement thereof. The reset lever may be attached to the drive sprocket. The reset lever may be movable with the drive sprocket relative to the housing to vary tension at the chain. The gear plate may be movably disposed within the interior and support the drive sprocket. The system motor may be mounted on the gear plate in mechanical communication with the drive sprocket to motivate rotation thereof. The toothed rack may be fixed relative to the housing within the interior. The pawl may be pivotably supported on the gear plate in selective engagement with the toothed rack.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of an outdoor tool in accordance with embodiments of the present disclosure;

FIG. 2 is another perspective view of the exemplary outdoor tool of FIG. 1;

FIG. 3 is an elevation view of a side portion of the exemplary outdoor tool of FIG. 1, wherein a portion of a housing has been omitted for clarity;

FIG. 4 is a perspective view of a portion of the exemplary outdoor tool of FIG. 1, wherein various elements have been omitted for clarity;

FIG. 5 is another perspective view of a portion of the exemplary outdoor tool of FIG. 1, wherein additional various elements have been omitted for clarity;

FIG. 6 is yet another perspective view of a portion of the exemplary outdoor tool of FIG. 1, wherein more additional various elements have been omitted for clarity;

FIG. 7 is yet another perspective view of a portion of the exemplary outdoor tool of FIG. 1, wherein yet additional various elements have been omitted for clarity;

FIG. 8 is yet another perspective view of a portion of the exemplary outdoor tool of FIG. 1, wherein yet more additional various elements have been omitted for clarity;

FIG. 9 is a perspective view of a portion of an outdoor tool, including a housing, according to exemplary embodiments of the present disclosure;

FIG. 10 is a perspective view of a portion of the exemplary outdoor tool of FIG. 9, wherein various elements have been omitted for clarity;

FIG. 11 is an elevation view of a side portion of the exemplary outdoor tool of FIG. 9, wherein a portion of a housing has been omitted for clarity;

FIG. 12 is another perspective view of a portion of the exemplary outdoor tool of FIG. 9, wherein additional various elements have been omitted for clarity;

FIG. 13 is yet another an elevation view of a side portion of the exemplary outdoor tool of FIG. 9, wherein more additional various elements have been omitted for clarity;

FIG. 14 is another perspective view of a portion of the exemplary outdoor tool of FIG. 9, wherein yet more additional various elements have been omitted for clarity;

FIG. 15 is another perspective view of a portion of the exemplary outdoor tool of FIG. 9, wherein yet more additional various elements have been omitted for clarity;

FIG. 16 is another perspective view of a portion of the exemplary outdoor tool of FIG. 9, wherein yet more additional various elements have been omitted for clarity;

FIG. 17 is another perspective view of a portion of the exemplary outdoor tool of FIG. 9, wherein yet more additional various elements have been omitted for clarity;

FIG. 18 is another perspective view of a portion of the exemplary outdoor tool of FIG. 9, wherein yet more additional various elements have been omitted for clarity; and

FIG. 19 provides a flow chart illustrating a method of operating a tool according to exemplary embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, aspects of the present disclosure provide an outdoor tool or chainsaw having a system for maintaining tension at the chain. For instance, the system may bias the chain at a drive sprocket for rotating the chain. The guide bar of the chainsaw may remain stationary while biasing the chain. Notably, the assembled system may maintain tension at the chain automatically (e.g., without direct intervention or correction by a user).

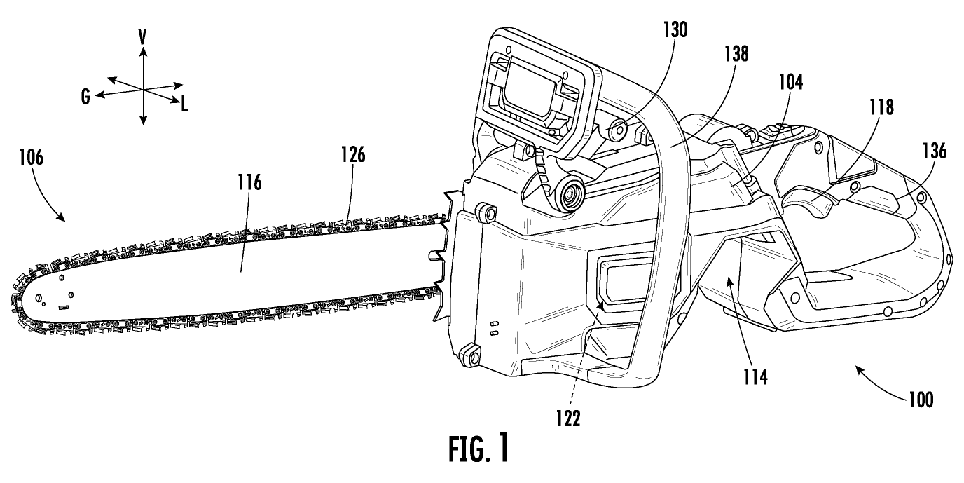

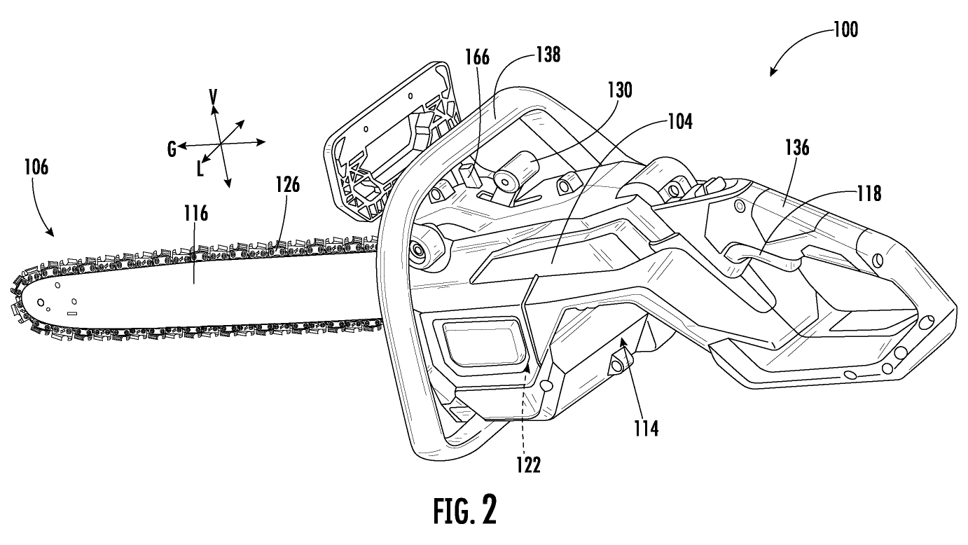

Referring now to the drawings, FIGS. 1 and 2 illustrate perspective views of a tool 100 in accordance with exemplary embodiments of the present disclosure. In particular, the tool 100 shown in FIG. 1 is a chain saw. In some embodiments, the tool 100 includes a housing 104. Moreover, the tool 100 can further include a guide bar assembly or tool unit 106 including a guide bar 116 that receives a chain 126, e.g., circumscribed around the guide bar 116. As will be described in greater detail below, the tool 100 may further include a motor assembly 110 (e.g., within the housing 104).

As shown, an orthogonal coordinate system may be defined for the chainsaw 100, and may include a longitudinal axis G, a lateral axis L, and a vertical axis V, all of which may be mutually orthogonal to each other. When assembled, guide bar 116 may extend from housing 104 along the longitudinal axis G.

In some embodiments, housing 104 generally defines an interior 122. The guide bar 116 can extend from the housing 104, such that at least a portion (e.g. an end portion) of the guide bar 116 extends into and is disposed in the interior 122. For example, housing 104 can include a guide bar 116 cover portion that is connected to a main housing portion. The guide bar 116 can extend between the main housing portion and the guide bar 116 cover portion such that the end portion is within the interior 122. A fastener assembly, which may for example include bolts, screws, and/or other suitable hardware, may mount the guide bar 116 to the housing 104, such as to the guide bar 116 cover portion or the main housing portion. As will be described in greater detail below, the guide bar 116 may be fixed relative to housing 104 (e.g., even during steps for increasing or decreasing tension at the chain 126).

The tool 100 can include a variety of features and configurations to facilitate the handling and operation of the tool 100 by a user. For instance, the housing 104 may include a first handle 136 (e.g., a rear handle) coupled between a battery pack receptacle or receiver 114 and a front portion of the housing 104. As such, the first handle 136 extends in a direction along the longitudinal axis of the guide bar 116. In addition, the housing 104 includes a second handle 138 (e.g., an elongated curved bar; front handle) coupled between the first handle 136 and a sidewall of the battery pack receptacle 114.

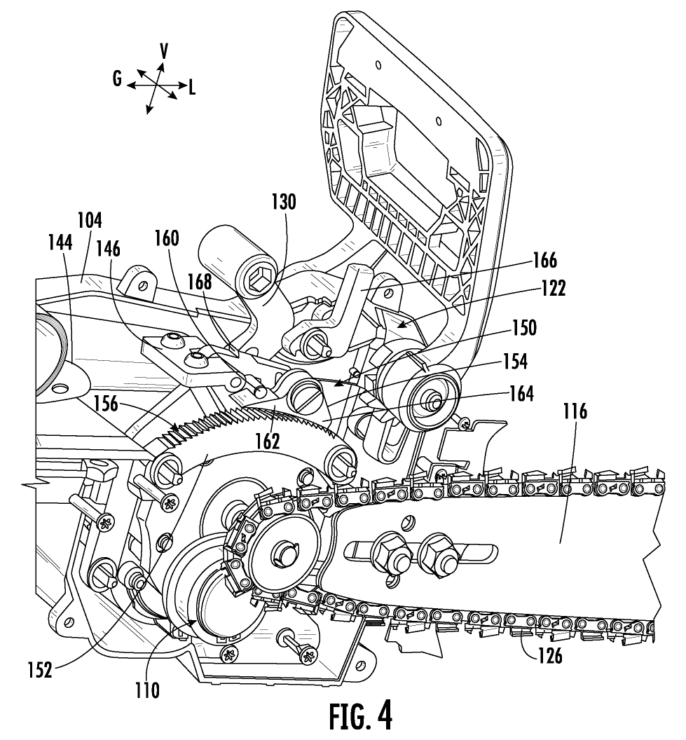

The chainsaw 100 can further include a system motor 110 or motor assembly 110, such as a gas powered engine or an electric motor (as shown). In some exemplary embodiments, at least a portion of the motor assembly 110, such as the entire motor assembly 110, is disposed in the interior 122. The motor assembly 110 may be operable to move the chain 126 relative to the guide bar 116. For example, the motor assembly 110 may drive a drive sprocket 128 (FIG. 4). The drive sprocket 128 can be engaged with the chain 126 such that rotation of the drive sprocket 128 causes the chain 126 to move relative to the guide bar 116. By way of non-limiting example, the motor assembly 110 can include a motor having an output or drive shaft. The drive shaft can be in communication with the chain 126, e.g., through a transmission having a drive sprocket 128, so as to move the chain 126 along the guide bar 116. For instance, the drive sprocket 128 may be rotatably coupled to the transmission, and the chain 126 may be in operable communication with the drive sprocket 128 (e.g., the chain 126 may circumscribe a portion of the drive sprocket 128) such that the drive sprocket 128 can drive the chain 126 about the guide bar 116. The motor assembly 110 can be powered, for example, by a rechargeable energy source such as a battery, which may be received within the battery pack receptacle 114, or by another means such as an internal combustion engine.

A user interface, e.g., a trigger 118, can be disposed at a location whereby an operator can control operation of the tool 100, such as on the first handle 136. The trigger 118 can control the motor assembly 110 of the tool 100 to drive the chain 126 along the guide bar 116. When the trigger 118 is activated, e.g., depressed, the speed of the motor assembly 110 can increase. Conversely, when the trigger 118 is deactivated, e.g., not depressed, the motor assembly 110 can stop.

As noted above, the motor assembly 110 may include or be provided as any general source of power to directly, or indirectly, move the chain 126 around the guide bar 116, such as an electric motor or internal combustion engine. Optionally, the motor assembly 110 may be a variable speed motor and a relative activated position of the trigger 118 can inform the speed of the variable speed motor. That is, the operator can control the speed of the chain 126 along the guide bar 116 based on how far the trigger 118 is depressed. One or more secondary user interfaces, e.g., a power button, can be used to control another aspect of the tool 100. A power button can include, for example, a toggle which can be moved between ON and OFF positions. The tool 100 may not function when the power button is in the OFF position and the ON/OFF toggle may be biased to the OFF position such that a user must hold the toggle in the ON position while simultaneously depressing the trigger 118 to engage the motor assembly 110. Alternatively, the ON/OFF toggle can function as an interlock that prevents depression of the trigger 118 unless held in the ON position.

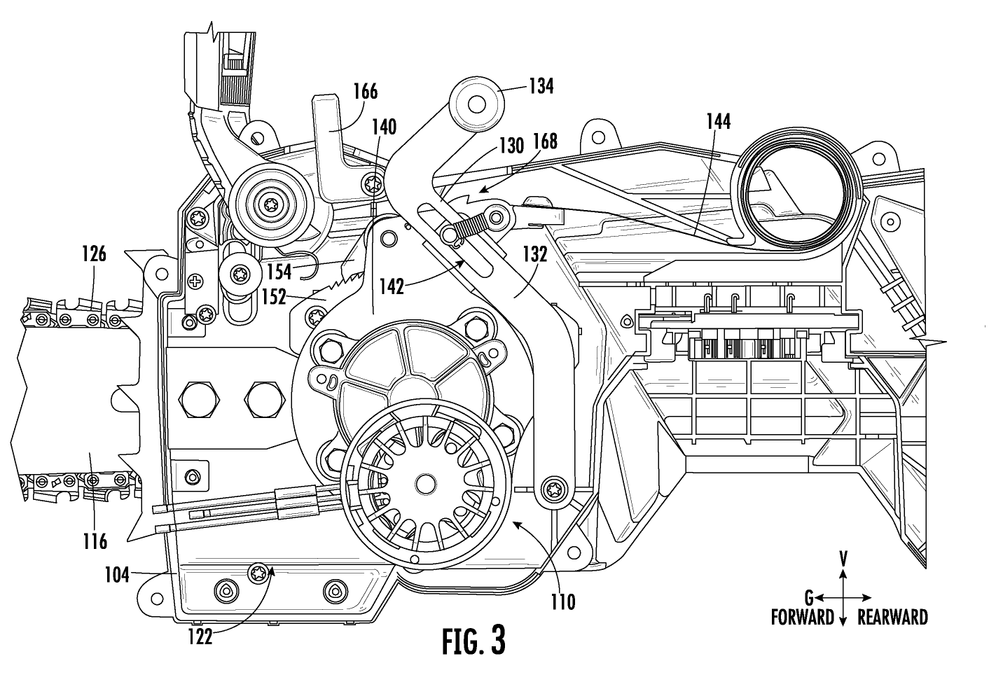

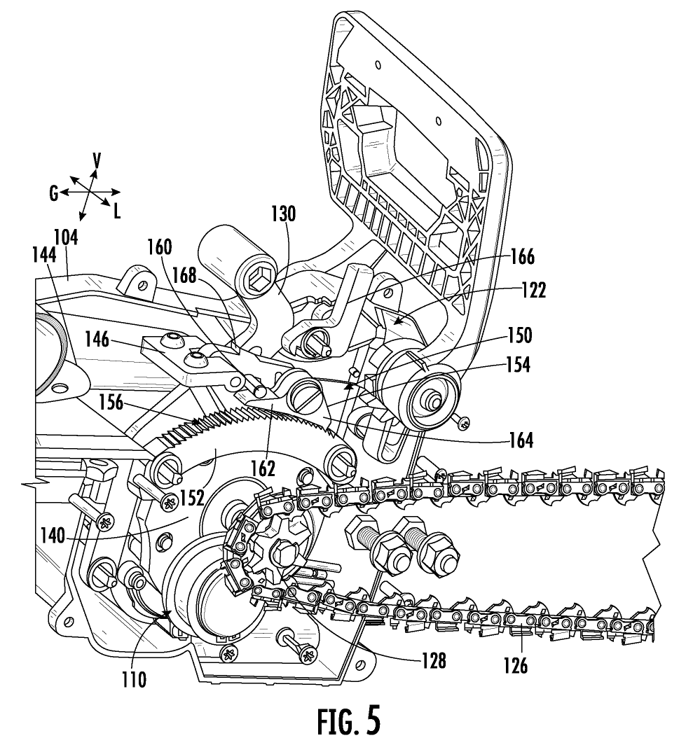

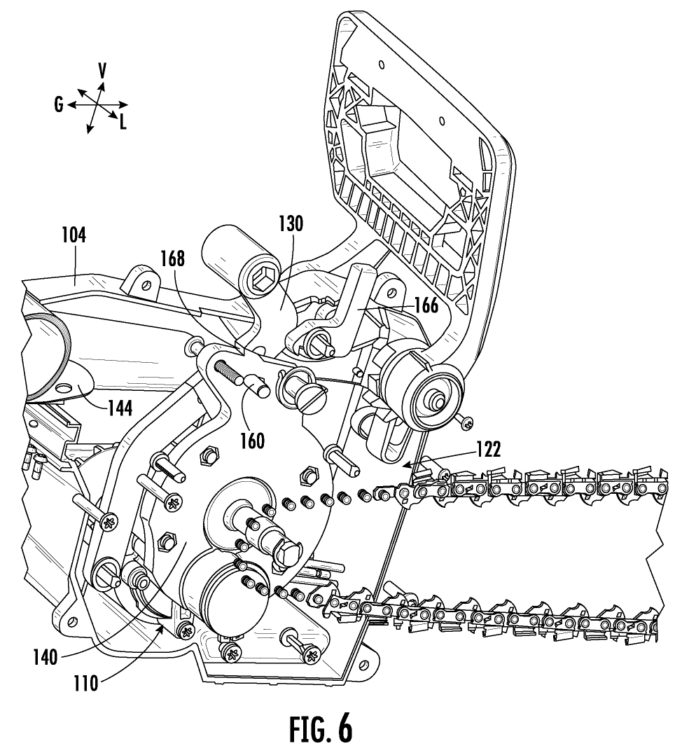

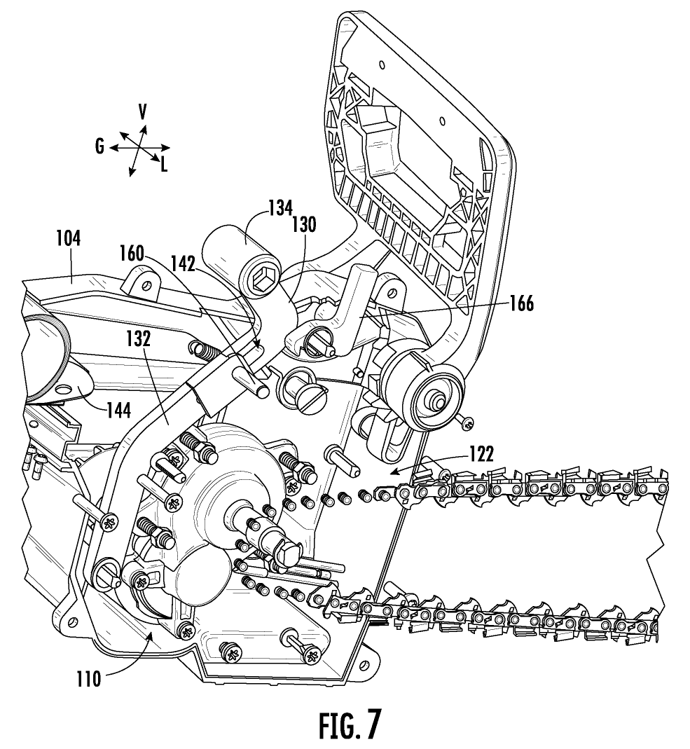

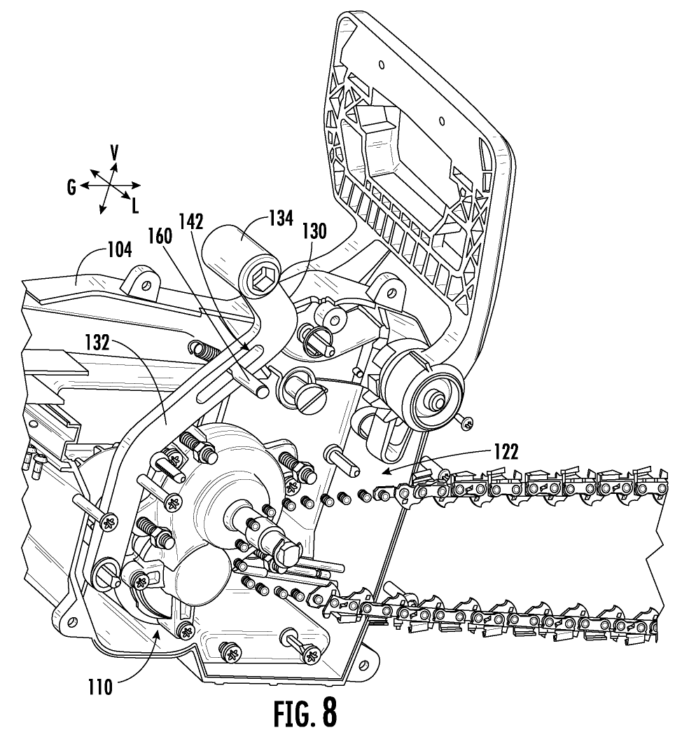

Referring now to FIGS. 3 through 8, various views are provided illustrating components mounted on or within housing 104 (e.g., within interior 122) according to certain embodiments of the present disclosure. For instance, a reset lever 130 is generally provided on or within the housing 104 to move the drive sprocket 128 (e.g., relative to the chain 126 or guide bar 116). As shown, the reset lever 130 may include a primary body 132 held, at least in part, within the interior 122. Outside of the interior 122, a lever handle 134 may be provided, such as to generally extend vertically above an upper wall or portion of housing 104.

When assembled, reset lever 130 is attached (e.g., indirectly) to the drive sprocket 128 to move the drive sprocket 128 (e.g., at least in part along the longitudinal direction G). Thus, the reset lever 130 may generally be movable (e.g., longitudinally). For instance, the reset lever 130 may be pivotable about a set axis (e.g., parallel to the lateral direction L). During use, a user may, thus, engage the reset lever 130 (e.g., at the lever handle 134) to move the reset lever 130 longitudinally forward or rearward. In turn, reset lever 130 may be movable with drive sprocket 128 (e.g., alternately forward or rearward), such as to vary tension at the chain 126.

In some embodiments, a gear plate 140 is provided to support one or more other components. For instance, gear plate 140 may support drive sprocket 128 (e.g., such that gear plate 140 is fixed relative to drive sprocket 128). As shown, gear plate 140 may be mounted to housing 104, such as within interior 122. Additionally or alternatively, gear plate 140 may be movable (e.g., longitudinally, such as by pivoting about a lateral axis) relative to at least a portion of housing 104. In certain embodiments, the gear plate 140 is connected to the reset lever 130. For instance, the reset lever 130 may define a slot 142 within the primary body 132 (e.g., laterally through the primary body 132 and extending therealong at a non-parallel angle relative to the vertical direction V and the longitudinal direction G). A lateral pin 160 secured or fixed to the gear plate 140 may extend within the slot 142. In turn, the reset lever 130 and gear plate 140 may generally move in tandem (e.g., forward or rearward) while having discrete pivot or travel paths along which each moves.

As noted above, a motor assembly or system motor 110 may generally be provided to drive rotation of the chain 126 (e.g., via drive sprocket 128). In some embodiments, system motor 110 is mounted on the gear plate 140. Specifically, system motor 110 may be supported on and fixed relative to gear plate 140. In turn, system motor 110 may move on or within housing 104 in tandem with the gear plate 140. Separate from or in addition to being supported on gear plate 140, system motor 110 may be in mechanical communication and, thus, motivate or drive rotation of the chain 126 (e.g., as described above). In some embodiments, one or more intermediate gears or gear train may be provided in mechanical communication between system motor 110 and drive sprocket 128 (e.g., the driveshaft thereof). In turn, such intermediate gearing may further be mounted on the gear plate 140 (e.g., to move therewith relative to housing 104).

In certain embodiments, a tensioning spring 144 is attached to the drive sprocket 128. For instance, the tensioning spring 144 may be attached at a movable or free end to the drive sprocket 128 (e.g., indirectly, such as via the gear plate 140 or the reset lever 130). For instance, a spring joint 146 fixed to the movable or free end may include a joint catch received on or within a portion of gear plate 140. An opposite or anchored end of the tensioning spring 144 may be attached or secured to the housing 104 (e.g., within an anchor cavity counterbalancing tension within the tensioning spring 144). When assembled, tensioning spring 144 may bias the drive sprocket 128 longitudinally rearward (e.g., via the gear plate 140, as shown). In turn, tensioning spring 144 may be attached to the drive sprocket 128 in rearward biased engagement to bias the drive sprocket 128 longitudinally rearward. Notably, the rearward bias of the drive sprocket 128 may maintain tension within the chain 126 (e.g., even as the chain 126 expands or without requiring direct user intervention or adjustments).

Generally, tensioning spring 144 may include or be provided as any suitable type of spring or biasing element, such as a coil leaf spring, helical extension spring, torsion spring, disc spring, etc. In certain embodiments, a spring damper is provided in mechanical engagement with the tensioning spring 144. For instance, the spring damper may include or be provided as a friction wall (e.g., fixed to or formed as part of housing 104) impinging on a portion of the tensioning spring 144, such as within the anchor cavity or interior 122 generally. Additionally or alternatively, a fluid damper (e.g., damper strut) may be provided on or against the gear plate 140. When assembled, the spring damper may dampen the biasing force or movement induced against the drive sprocket 128 (e.g., at the gear plate 140), such as by the tensioning spring 144. In turn, releasing the gear plate 140 or drive sprocket 128 to re-tension the chain 126 may notably prevent the chain 126 from being snapped into tension, which may otherwise cause product damage or user harm.

In certain embodiments, a ratcheting lock assembly 150 is provided to permit selective locking of the drive sprocket 128 (e.g., relative to the housing 104 along the longitudinal direction G). As an example, the ratcheting lock assembly 150 may include a toothed rack 152 and a pawl 154 in selective (e.g., releasable or ratcheting) engagement with the toothed rack 152.

In some embodiments, the toothed rack 152 is fixed relative to the housing 104. For instance, one or more mechanical fasteners, welds, or adhesives may join toothed rack 152 to housing 104 (e.g., within interior 122). Thus, the relative position of the toothed rack 152 and housing 104 may be maintained (e.g., even as the drive sprocket 128 or gear plate 140 moves relative to the housing 104). Optionally, the toothed rack 152 may be curved (e.g., as an arc having a curve defining a centerpoint). As shown, the toothed rack 152 generally includes a plurality of ratchet teeth 156. Such ratchet teeth 156 may be slanted, for instance, rearward. In some such embodiments, one or more of the teeth include two or more faces, including a rear face directed rearward and a forward face directed forward. One or both faces may be angled away from the forward direction. The angle or rake of the forward face may be greater (e.g., relative to the vertical direction V or centerpoint of the curve of the toothed rack 152) than the rearward face. Thus, the pawl 154 may be able to move rearwardly (e.g., in ratcheting travel) while being generally restricted or resistant to forward movement relative to the toothed rack 152.

Although pivotable (e.g., about a set lateral pivot axis), the general position of the pawl 154 (e.g., as defined by the location of the set lateral pivot axis of the pawl 154) relative to the drive sprocket 128 may be fixed. Thus, longitudinal movement of the drive sprocket 128 may match or be simultaneous with longitudinal movement of the drive sprocket 128. In some embodiments, the pawl 154 is pivotably supported on the gear plate 140. For instance, the pivot axis of the pawl 154 may be defined on the gear plate 140. Thus, the pawl 154 may move with the gear plate 140, even while separately being pivotable about the corresponding pivot axis. In additional or alternative embodiments, the pawl 154 is attached (e.g., pivotably) to the reset lever 130. The reset lever 130 may be movable relative to the pawl 154 (e.g., separately from the pivoting motion of the pawl 154). Optionally, the reset lever 130 may further be in mechanical engagement with the pawl 154 (e.g., to motivate pivoting of the pawl 154). As shown, the reset lever 130 may include a lateral pin 160 slidably disposed on the pawl 154 to motivate pivoting movement of the pawl 154. For instance, the lateral pin 160 may rest against a curved upper surface of a lever arm 162 of the pawl 154—the lever arm 162 being opposite of a toothed arm 164 of the pawl 154. The reset lever 130 may be movable on the lever arm 162 between an outer position distal to the pivot axis and an inner position proximal to the pivot axis. Movement of the lateral pin 160 from the outer position to the inner position (e.g., forward) may motivate the toothed arm 164 to pivot upward, thereby disengaging the pawl 154 from the toothed rack 152 and permitting further forward movement of the pawl 154—and thus the gear plate 140—relative to the toothed rack 152 and housing 104.

In exemplary embodiments, a release input 166 is provided in selective engagement with the reset lever 130 (e.g., directly or indirectly), such as to selectively hold the reset lever 130 in a predetermined longitudinal position. For instance, the release input 166 may be positioned to engage the reset lever 130 at a forward position or relaxed position of the drive sprocket 128. In some embodiments, the release input 166 engages the reset lever 130 via the gear plate 140. For instance, the gear plate 140 may include a forward catch 168. The release input 166 may provide a latch that is configured to hook against the forward catch 168. Thus, as the reset lever 130 and gear plate 140 are moved to the forward position, the latch of the release input 166 may be brought into engagement with the forward catch 168. Engagement by the release input 166 may hold or maintain the drive sprocket 128 at the forward position, such as to permit adjustment or replacement of the chain 126. As shown, the release input 166 may be movably mounted to housing 104. For instance, the release input 166 may be pivotable. In the illustrated embodiments, the release input 166 may be pivoted (e.g., by a user) to release the gear plate 140 and drive sprocket 128.

It is noted that although the release input 166 is illustrated as a pivotable lever, additional or alternative embodiments of the release input 166 may include another suitable selectively releasable structure, such as a ball and detent actuator, to selectively secure and release the reset lever 130 or gear plate 140 at/from the forward position.

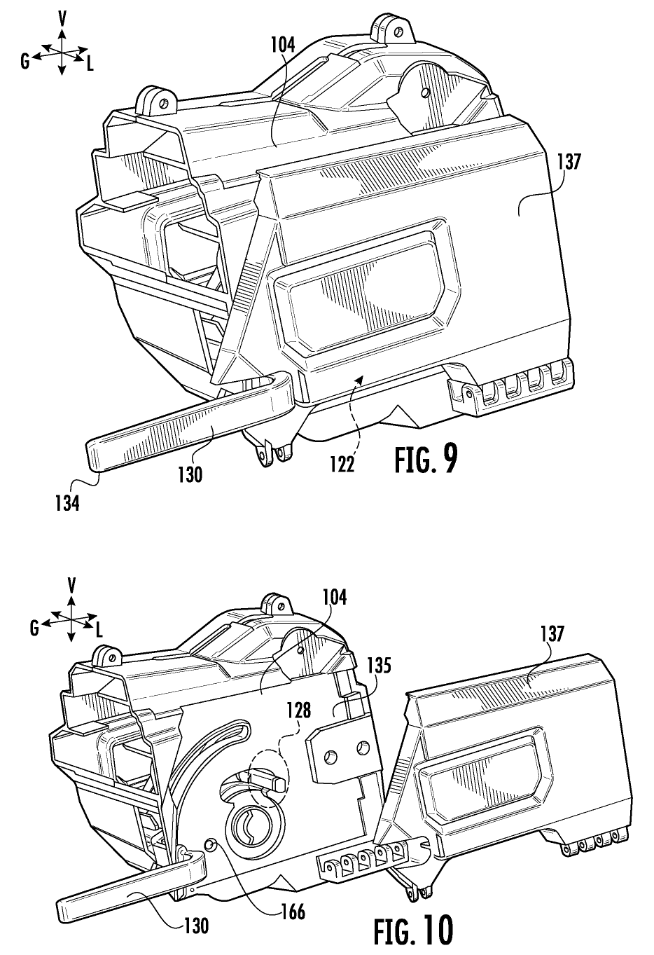

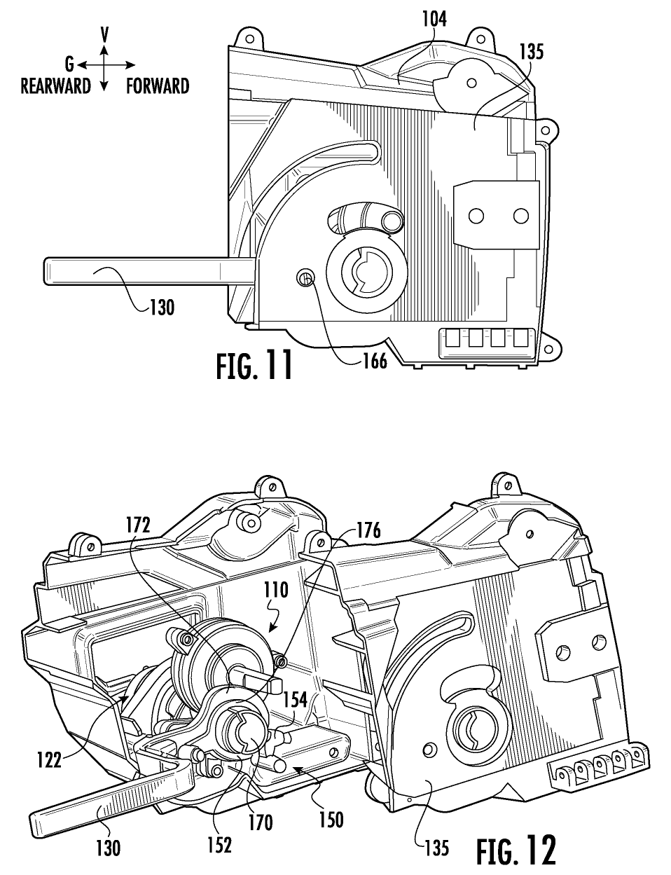

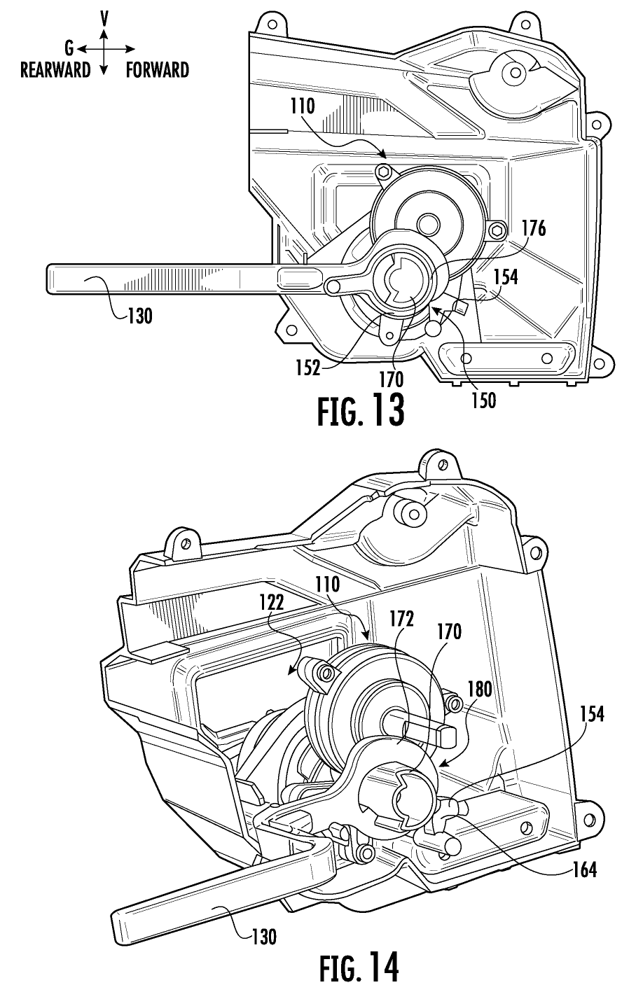

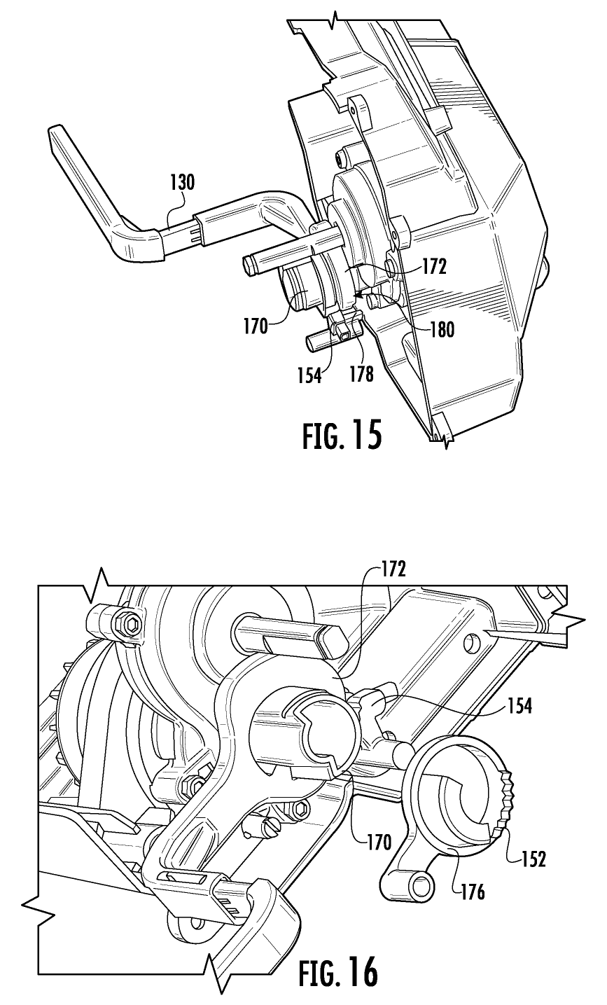

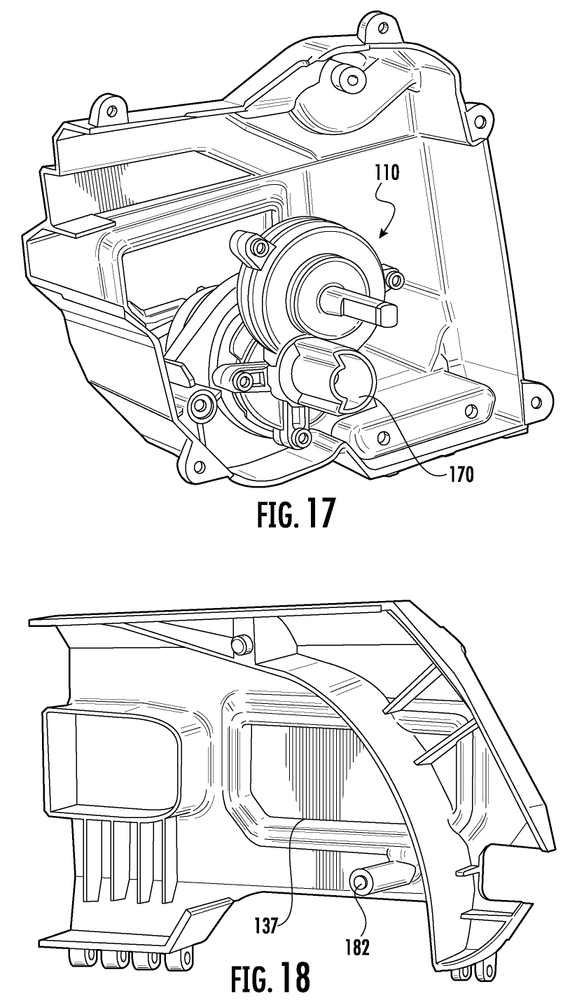

Turning now to FIGS. 9 through 18, various views are provided illustrating components mounted on or within housing 104 (e.g., within interior 122) according to other embodiments of the present disclosure. It is noted that the above disclosure relating to embodiments illustrated in FIGS. 1 through 8 is understood to be generally applicable to the embodiments of FIGS. 9 through 18, except as otherwise indicated or in conflict.

As shown, a reset lever 130 is generally provided on or within the housing 104 to move the drive sprocket 128 (e.g., relative to the chain or guide bar). As shown, the reset lever 130 may include a primary body 132 held, at least in part, within the interior 122. Outside of the interior 122, a lever handle 134 may be provided, such as to generally extend horizontally at a location below an upper wall or portion of housing 104, notably avoiding interference or overlap with another handle of the power tool.

When assembled, reset lever 130 is attached (e.g., indirectly) to the drive sprocket 128 to move the drive sprocket 128 (e.g., at least in part along the longitudinal direction G). Thus, the reset lever 130 may generally be movable (e.g., along a set path or arc). For instance, the reset lever 130 may be pivotable about a set axis (e.g., parallel to the lateral direction L). During use, a user may, thus, engage the reset lever 130 (e.g., at the lever handle 134) to move the reset lever 130 upward and longitudinally forward or downward and longitudinally rearward. In turn, reset lever 130 may be movable with drive sprocket 128 (e.g., alternately forward or rearward), such as to vary tension at the chain 126. Optionally, an internal wall 135 of the housing may define a lever slot within at least partially defining a travel path of the reset lever 130 and within which the reset lever 130 is received (e.g., at a forwardmost position). Additionally or alternatively, the internal wall 135 may define a discrete shaft slot at least partially defining a travel path of the driveshaft of the drive sprocket and within which the driveshaft is received. When assembled, an outer panel 137 or shell may cover the internal wall 135 such that movement or removal of the outer panel 137 is required before permitting a user access to the lever slot or shaft slot.

In some embodiments, the reset lever 130 is attached to the motor assembly 110. For instance, a casing post 170 (e.g., fixed to or formed with) a casing of the motor assembly 110 may be mated to a matched wrench head 172 of the reset lever 130 (e.g., within the interior opposite the handle). Optionally, the casing post 170 may define a circumferential gap within which a wrench tooth of the wrench head 172 is received. In some such embodiments, the wrench tooth is sized significantly smaller than the circumferential gap such that a predefined angular distance of travel within the circumferential gap is permitted. In turn, the reset lever 130 may be permitted to move along or by the predefined angular distance before movement at the reset lever 130 is transferred to the casing post 170 and motor assembly 110 (e.g., and thereby the drive sprocket).

In certain embodiments, a tensioning spring (not pictured) is attached to the drive sprocket 128. For instance, the tensioning spring may be attached at a movable or free end to the drive sprocket 128 (e.g., indirectly, such as via attachment to a casing of the system motor 110 or the reset lever 130). As described above, tensioning spring 144 may bias the drive sprocket 128 longitudinally rearward. Notably, the rearward bias of the drive sprocket 128 may maintain tension within the chain (e.g., even as the chain expands or without requiring direct user intervention or adjustments).

In certain embodiments, a ratcheting lock assembly 150 is provided to permit selective locking of the drive sprocket 128 (e.g., relative to the housing 104 along the longitudinal direction G). As an example, the ratcheting lock assembly 150 may include a toothed rack 152 and a pawl 154 in selective (e.g., releasable or ratcheting) engagement with the toothed rack 152.

In some embodiments, the toothed rack 152 is fixed relative to the casing post 170. For instance, the toothed rack may be formed on an outer perimeter of a wrench ring 176 disposed on the casing post 170 (e.g., to rotate therewith). As shown, the wrench ring 176 may include a complementary tooth matched to the circumferential gap such that rotation of the casing post 170 is generally matched by the wrench ring 176 and, thus, the toothed rack 152. As shown, the toothed rack 152 generally includes a plurality of ratchet teeth 156.

The pawl 154 may be pivotably mounted within the interior 122. In some embodiments, the pivot axis defined by the pawl 154 is fixed relative to the housing 104. The pivot axis of the pawl 154 may be disposed below a rotation axis of the toothed rack 152 or casing post 170. The toothed arm of the pawl may extend above the pivot axis of the pawl. Nonetheless, the toothed arm of the pawl may be disposed below the rotation axis of the toothed rack 152 or casing post 170. The pawl may be disposed forward from the casing post 170. A biasing spring (not pictured) may be provided in engagement with the pawl, motivating the pawl rearward to engage the toothed rack. When assembled and in engagement with the toothed rack 152, the pawl may ratchet to permit rearward or counterclockwise rotation of the casing post 170 while generally restricting forward or clockwise rotation of the casing post 170.

Optionally, a lateral finger 178 may extend from a side face of the pawl (e.g., radially offset from the pivot axis) to rotate therewith. A lever cam 180 (e.g., attached or fixed to the reset lever 130) may be provided in selective engagement with the lateral finger. For instance, the lever cam 180 may be formed on an outer perimeter of the wrench head 172 to engage the lateral finger 178 during forward or clockwise rotation of the reset lever 130. Forward movement of the cam 180 may thus motivate the lateral finger 178 and toothed arm 164 to forward, thereby disengaging the pawl 154 from the toothed rack 152 and permitting further forward movement of the system motor 110 relative to the housing 104.

In exemplary embodiments, a release input 166 is provided in selective engagement with the reset lever 130 (e.g., directly or indirectly), such as to selectively hold the reset lever 130 in a predetermined rotational position. For instance, the release input 166 may be supported on a radial arm extending from the wrench ring 176. In the illustrated embodiments, the release input 166 includes an actuator pin slidably disposed within a pin casing on the radial arm. The actuator pin may be biased laterally outward, such as by a pin spring (not pictured) held within the pin casing. The actuator pin may be configured to engage a catch hole (e.g., defined in the internal wall 135). Thus, as the reset lever 130 and casing post 170 are moved to a forward position, the actuator pin of the release input 166 may be brought into engagement with the catch hole (e.g., by springing laterally outward into the catch hole). Engagement by the casing pin may hold or maintain the drive sprocket 128 at the forward position, such as to permit adjustment or replacement of the chain 126.

In optional embodiments, the outer panel 137 includes an internal post 182 that generally extends to and aligns with the catch hole. In an assembled position of the outer panel 137, the internal post 182 may, thus, extend into the catch hole, thereby blocking or otherwise preventing the actuator pin from being received within the catch hole and locking the drive sprocket forward. By contrast, removal of the outer panel 137 from the rest of housing 104 or internal wall 135 (e.g., to a disassembled or maintenance position) may permit the actuator pin from being received within the catch hole. Thus, during chain maintenance operations, a user may remove the outer panel 137 (e.g., to the disassembled or maintenance position) and subsequently use the reset lever 130 to move the drive sprocket to the forward position (e.g., such that the chain is untensioned). Once such maintenance is complete, the user may return the outer panel 137 to the assembled position, pressing the internal post 182 inward against the actuator pin and thereby disengaging the actuator pin from the catch hole and permitting the drive sprocket to be drawn rearward (e.g., as motivated by the tension spring) and tensioning the chain.

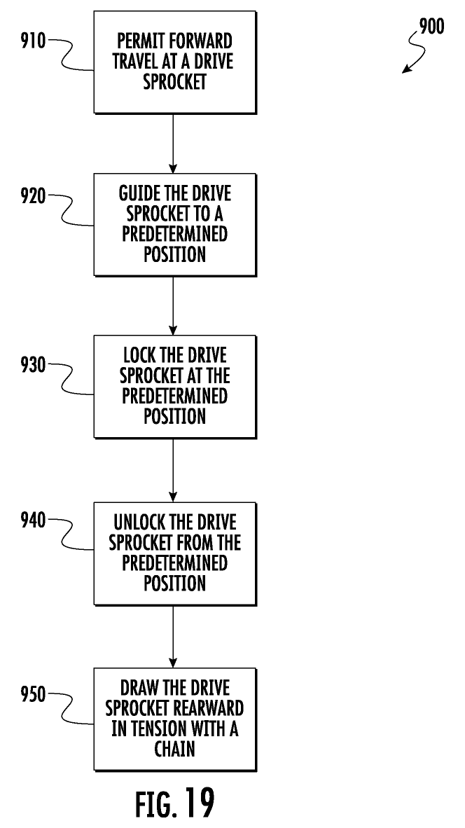

Turning now to FIG. 19, the present disclosure may further be directed to methods (e.g., method 900) of operating a power tool, such as power tool 100.

It is noted that the order of steps within method 900 is for illustrative purposes. All may be adopted or characterized as being fulfilled in a common operation. Except as otherwise indicated, one or more steps in the below method 50900 may be changed, rearranged, performed in a different order, or otherwise modified without deviating from the scope of the present disclosure.

At 910, the method 900 includes permitting forward travel at a drive sprocket. For instance, a pawl configured to engage a toothed rack may be moved apart from and disengaged from the toothed rack, as described above. Optionally, an outer panel or shell may be required to be removed from an internal wall or remaining portion of the housing.

At 920, the method 900 includes guiding the drive sprocket to a predetermined position. For instance, as described above, a reset lever attached to the drive sprocket may be permitted to move forward or upward, as described above. The predetermined position may be a forward position at which a chain is determined to be untensioned (e.g., such that the chain may be removed from a guide bar or the drive sprocket).

At 930, the method 900 includes locking the drive sprocket at the predetermined position. Specifically, a release input may engage the drive sprocket (e.g., indirectly) such that further pivoting or longitudinal movement is restricted, as described above.

At 940, the method 900 includes unlocking the drive sprocket from the predetermined position. As an example, upon being pivoted (e.g., forward by a user) the release input may release a gear plate and drive sprocket. Once released, the the drive sprocket (e.g., with the system motor and gear plate) may be permitted to travel (e.g., rearward as motivated by a tension spring). As another example, upon an outer panel or shell being moved to an assembled position, the actuator pin of the release input may be moved inward by an internal post and out of a catch hole, releasing the wrench ring and system motor to pivot (e.g., rearward as motivated by a tension spring).

As described above, the drive sprocket may be biased rearward, such as by a tension spring, thereby applying a constant tension to the chain, even as the chain stretches or expands.

Further aspects of the disclosure are provided by one or more of the following embodiments:

A chainsaw defining a mutually orthogonal vertical, lateral, and longitudinal direction, comprising: a guide bar comprising an outer track; a chain movably coupled to the outer track; a housing defining an interior; a drive sprocket mounted on the housing in mechanical communication with the chain to motivate movement thereof; and a reset lever attached to the drive sprocket, the reset lever being longitudinally movable with the drive sprocket relative to the housing to vary tension at the chain.

The chainsaw of any one or more of the embodiments, further comprising a tensioning spring attached to the drive sprocket in rearward biased engagement to bias the drive sprocket longitudinally rearward.

The chainsaw of any one or more of the embodiments, further comprising: a gear plate movably disposed within the interior and on which the drive sprocket is supported, wherein the tensioning spring is attached to the gear plate to move therewith.

The chainsaw of any one or more of the embodiments, wherein the reset lever defines a slot through which the gear plate connects to the reset lever.

The chainsaw of any one or more of the embodiments, further comprising: a system motor mounted on the gear plate in mechanical communication with the drive sprocket to motivate rotation thereof.

The chainsaw of any one or more of the embodiments, further comprising: a toothed rack fixed relative to the housing; and a pawl pivotably attached to the reset lever in selective engagement with the toothed rack.

The chainsaw of any one or more of the embodiments, further comprising: a gear plate movably disposed within the interior and on which the drive sprocket is supported, wherein the pawl is supported on the gear plate.

The chainsaw of any one or more of the embodiments, wherein the reset lever comprises a lateral pin slidably disposed on the pawl to motivate pivoting movement thereof.

The chainsaw of any one or more of the embodiments, further comprising: a release input in selective engagement with the reset lever to selectively hold the reset lever in a predetermined longitudinal position.

The chainsaw of any one or more of the embodiments, wherein the guide bar is fixed relative to the housing.

A chainsaw defining a mutually orthogonal vertical, lateral, and longitudinal direction, comprising: a housing defining an interior; a guide bar fixed relative to the housing, the guide bar comprising an outer track; a chain movably coupled to the outer track; a drive sprocket mounted on the housing in mechanical communication with the chain to motivate movement thereof; a reset lever attached to the drive sprocket, the reset lever being movable with the drive sprocket relative to the housing to vary tension at the chain; and a tensioning spring attached to the drive sprocket and the reset lever in rearward biased engagement.

The chainsaw of any one or more of the embodiments, further comprising: a gear plate movably disposed within the interior and on which the drive sprocket is supported, wherein the drive sprocket is attached to the gear plate to move therewith.

The chainsaw of any one or more of the embodiments, wherein the reset lever defines a slot through which the gear plate connects to the reset lever.

The chainsaw of any one or more of the embodiments, further comprising: a system motor mounted on the gear plate in mechanical communication with the drive sprocket to motivate rotation thereof.

The chainsaw of any one or more of the embodiments, further comprising: a toothed rack fixed relative to the housing; and a pawl pivotably attached to the reset lever in selective engagement with the toothed rack.

The chainsaw of any one or more of the embodiments, further comprising: a gear plate movably disposed within the interior and on which the drive sprocket is supported, wherein the pawl is supported on the gear plate.

The chainsaw of any one or more of the embodiments, wherein the reset lever comprises a lateral pin slidably disposed on the pawl to motivate pivoting movement thereof.

The chainsaw of any one or more of the embodiments, further comprising: a release input in selective engagement with the reset lever to selectively hold the reset lever in a predetermined longitudinal position.

A chainsaw defining a mutually orthogonal vertical, lateral, and longitudinal direction, comprising: a housing defining an interior; a guide bar fixed relative to the housing, the guide bar comprising an outer track; a chain movably coupled to the outer track; a drive sprocket mounted on the housing in mechanical communication with the chain to motivate movement thereof; a reset lever attached to the drive sprocket, the reset lever being movable with the drive sprocket relative to the housing to vary tension at the chain; a gear plate movably disposed within the interior, the gear plate may support the drive sprocket; a system motor mounted on the gear plate in mechanical communication with the drive sprocket to motivate rotation thereof; a toothed rack fixed relative to the housing within the interior; and a pawl pivotably supported on the gear plate in selective engagement with the toothed rack.

The chainsaw of any one or more of the embodiments, wherein the reset lever comprises a lateral pin slidably disposed on the pawl to motivate pivoting movement thereof.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A chainsaw defining a mutually orthogonal vertical, lateral, and longitudinal direction, comprising:
a guide bar comprising an outer track;
a chain movably coupled to the outer track;
a housing defining an interior;
a drive sprocket mounted on the housing in mechanical communication with the chain to motivate movement thereof; and
a reset lever attached to the drive sprocket, the reset lever being longitudinally movable with the drive sprocket relative to the housing to vary tension at the chain.

2. The chainsaw of claim 1, further comprising a tensioning spring attached to the drive sprocket in rearward biased engagement to bias the drive sprocket longitudinally rearward.

3. The chainsaw of claim 2, further comprising:
a gear plate movably disposed within the interior and on which the drive sprocket is supported,
wherein the tensioning spring is attached to the gear plate to move therewith.

4. The chainsaw of claim 3, wherein the reset lever defines a slot through which the gear plate connects to the reset lever.

5. The chainsaw of claim 3, further comprising:
a system motor mounted on the gear plate in mechanical communication with the drive sprocket to motivate rotation thereof.

6. The chainsaw of claim 1, further comprising:
a toothed rack fixed relative to the housing; and
a pawl pivotably attached to the reset lever in selective engagement with the toothed rack.

7. The chainsaw of claim 6, further comprising:
a gear plate movably disposed within the interior and on which the drive sprocket is supported,
wherein the pawl is supported on the gear plate.

8. The chainsaw of claim 7, wherein the reset lever comprises a lateral pin slidably disposed on the pawl to motivate pivoting movement thereof.

9. The chainsaw of claim 1, further comprising:
a release input in selective engagement with the reset lever to selectively hold the reset lever in a predetermined longitudinal position.

10. The chainsaw of claim 1, wherein the guide bar is fixed relative to the housing.

11. A chainsaw defining a mutually orthogonal vertical, lateral, and longitudinal direction, comprising:
a housing defining an interior;
a guide bar fixed relative to the housing, the guide bar comprising an outer track;
a chain movably coupled to the outer track;
a drive sprocket mounted on the housing in mechanical communication with the chain to motivate movement thereof;
a reset lever attached to the drive sprocket, the reset lever being movable with the drive sprocket relative to the housing to vary tension at the chain; and
a tensioning spring attached to the drive sprocket and the reset lever in rearward biased engagement.

12. The chainsaw of claim 11, further comprising:
a gear plate movably disposed within the interior and on which the drive sprocket is supported,
wherein the drive sprocket is attached to the gear plate to move therewith.

13. The chainsaw of claim 12, wherein the reset lever defines a slot through which the gear plate connects to the reset lever.

14. The chainsaw of claim 12, further comprising:
a system motor mounted on the gear plate in mechanical communication with the drive sprocket to motivate rotation thereof.

15. The chainsaw of claim 11, further comprising:
a toothed rack fixed relative to the housing; and
a pawl pivotably attached to the reset lever in selective engagement with the toothed rack.

16. The chainsaw of claim 15, further comprising:
a gear plate movably disposed within the interior and on which the drive sprocket is supported,
wherein the pawl is supported on the gear plate.

17. The chainsaw of claim 16, wherein the reset lever comprises a lateral pin slidably disposed on the pawl to motivate pivoting movement thereof.

18. The chainsaw of claim 11, further comprising:
a release input in selective engagement with the reset lever to selectively hold the reset lever in a predetermined longitudinal position.

19. A chainsaw defining a mutually orthogonal vertical, lateral, and longitudinal direction, comprising:
a housing defining an interior;
a guide bar fixed relative to the housing, the guide bar comprising an outer track;
a chain movably coupled to the outer track;
a drive sprocket mounted on the housing in mechanical communication with the chain to motivate movement thereof;
a reset lever attached to the drive sprocket, the reset lever being movable with the drive sprocket relative to the housing to vary tension at the chain;
a gear plate movably disposed within the interior, the gear plate may support the drive sprocket;
a system motor mounted on the gear plate in mechanical communication with the drive sprocket to motivate rotation thereof;
a toothed rack fixed relative to the housing within the interior; and
a pawl pivotably supported on the gear plate in selective engagement with the toothed rack.

20. The chainsaw of claim 19, wherein the reset lever comprises a lateral pin slidably disposed on the pawl to motivate pivoting movement thereof.
